(19) United States
(12) Patent Application Publication
(10) Pub. No.: US 2013/0264774 A1
(43) Pub. Date: Oct. 10, 2013

(54) Flange Joint and Method for Preventing a Fluid from Leaking Out Through a Flange Joint

(71) Applicants: James Phillip Bailor, Fairfax Station, VA (US); Carey Michael Hymel, Denham Springs, LA (US); Daniel Robert Bourgeois, Baton Rouge, LA (US); Omkar Ashok Namjoshi, Baton Rouge, LA (US); Nicolaas A. De Munck, Barendrecht (NL)

(72) Inventors: James Phillip Bailor, Fairfax Station, VA (US); Carey Michael Hymel, Denham Springs, LA (US); Daniel Robert Bourgeois, Baton Rouge, LA (US); Omkar Ashok Namjoshi, Baton Rouge, LA (US); Nicolaas A. De Munck, Barendrecht (NL)

(73) Assignee: ExxonMobil Chemical Patents Inc., Baytown, TX (US)

(21) Appl. No.: 13/878,008

(22) PCT Filed: Sep. 20, 2011
(86) PCT No.: PCT/EP2011/066260

§ 371 Date: Jun. 19, 2013

(30) Foreign Application Priority Data
Nov. 10, 2010 (EP) 10190724.4

(51) Int. Cl. F16L 17/10; F16J 15/14

(52) U.S. Cl. CPC F16L 17/10; F16J 15/14
USPC 277/314; 285/10; 422/129

(57) ABSTRACT

A method comprising forming a partial barrier in an outer part of a flange joint, applying a sealant to the outside of the flange joint, and supplying a safe sealing fluid to an inner part of the flange joint, prevents a process fluid from leaking out through a flange joint, advantageously without having to dismantle the flange joint.

### FIELD OF INVENTION

The invention relates to a flange joint and a method tier preventing a fluid from leaking out through a flange joint. In particular, but not exclusively, the invention relates to flange joints on vessels or pipelines.

### DESCRIPTION OF PRIOR ART

Flange joints are a well-known method for creating seals when joining two components together. Examples of places where flange joints may be employed include joints between segments of pipes, joints between sections of equipment and joints between pipes and equipment. Examples of equipment are pumps, heat exchangers, vessels, tanks, reactors, filters and centrifuges. In a typical flange joint, the ends of two components each have a flange, which takes the form of a plate-like structure surrounding the mouth of the component. The flanges are such that, when the mouths of the two components are brought together, the flanges on the two components are co-planar and adjacent one another. Bolts are threaded through holes in the flanges and tightened so as to draw the two flanges together, forming a seal between them. The seal may be improved by incorporating a gasket or a ring-joint between the flanges.

Section 13.10 of Coulson and Richardson's Chemical Engineering, Volume 6, Third Edition, pages 855-864, gives examples of flanges, gaskets and flange joints and discusses design considerations.

Pages 110-75 to 10-80 of Perry's Chemical Engineers' Handbook, Seventh Edition also describe flanges and gaskets and list examples of standard flanges. Page 10-145 of Perry's Chemical Engineers' Handbook, Seventh Edition discusses flanges on pressure vessels.

Over time, one or both of the flanges can become slightly warped, so that a gap develops between the flanges and the gasket. When that happens, fluid present inside the components can flow out through the gap. The fluid may, for example, be a gas, a liquid, a slurry or a mixture thereof. In many circumstances, environmental or health and safety considerations mean that such leaks cannot be tolerated. For example, toxic materials or materials that are flammable, or that can become explosive in certain mixtures cannot be permitted to leak through a flange joint. Also, financial considerations mean that high volume leakages or leakages of high-value products are undesirable. Repairs can often require shutdown of the facility so there is a need for a method of stopping leaks that can be applied while the process continues to operate.

U.S. Pat. No. 7,521,029 describes shell and tube reactors for carrying out catalytic gas phase reactions and a procedure for operating such reactors. Various techniques for purging dead spaces with a purge gas are discussed. However the purge gas is not used for leak prevention.

EP 1,050,699 describes the use of a non-harmful gas as a seal gas in a flanged connection of a vessel. The seal gas is introduced into a chamber derived from two tongue and groove gaskets, which are located in between the flanged connections. The gas is introduced through a predetermined drilled hole inside the flange. The hole can be drilled during manufacturing of the flanged connection or after dismantling the leaking flanged connection.

GB 2,189,857 describes packing seals located in between flanges and leak sealing clamps, which are suitable for on line leak sealing. The packing seals preferably comprise woven mineral or synthetic fibres impregnated with a thermosetting resin. The clamps are equipped with ports, which allow for the injection of thermosetting sealant or for pressure relief.

U.S. Pat. No. 4,568,091 describes a sealing system comprised of a sleeve to be mounted over a flanged connection, which sleeve has two spaced apart grooves which contain an elastomeric fluid pressure seal to provide a fluid tight seal within the space confined between the groves. The sealing system can further include a sealant

In the past, various methods have been used to resolve leaking flange joints. However, many of these methods suffer from significant drawbacks. For example, leaking flange joints on reactor vessels have often required replacement of part or all of the reactor, which is a big investment and involves lots of lost production time. In some cases a lip seal may be fitted, but that still requires dismantling of the reactor and is not possible if the flange deformation is too great. In some circumstances, external sealant may be used to seal the flange joint.

However, this is not suitable for many processes as the sealant will contact the process fluid. It is therefore necessary to use an external sealant that is compatible with the process fluid and will not react with it, which may not always be possible. Moreover, small quantities of the external sealant may migrate in through the flange joint and enter the process. In some processes, the presence of even small amounts of sealant can lead to potentially dangerous process conditions, contamination or off-specification product, which is not desirable.

The present invention seeks to ameliorate at least some of the aforementioned problems.

### STATEMENTS OF INVENTION

According to a first aspect of the invention, there is provided a method for preventing a process fluid from leaking out through a flange joint, the method comprising:
a. forming a partial barrier in an outer part of the flange joint;
b. applying a sealant to the outside of the flange joint, the partial barrier restricting ingress of the sealant into the flange joint; and
c. supplying a safe sealing fluid, at a pressure higher than the pressure of the process fluid, to an inner part of the flange joint, such that the safe sealing fluid prevents the process fluid from leaking out through the flange joint and prevents contact between the process fluid and the sealant, wherein the safe sealing fluid is supplied through a slotted stud in the flange joint.

Advantageously, the method can be carried out without dismantling the flange joint, and in some cases may even be carried out without shutting down the process being carried out inside the apparatus on which the flange joint is situated. The method may be applied to joints with large deformations in the flanges.

Flange joints are well known by a person skilled in the art and typically comprise two flanges with a gasket sandwiched between them. The invention may be applied to any suitable flange joint, including, but not limited to, full-face flange joints, narrow faced flange joints, flange joints formed from slip-on, screwed, socket weld, lap-joint and welding neck flanges and flange joints formed from standard flanges according to BS 1560, BS 4504, BS 3293, 9S3292, ANSI B16.1, ANSI B16.5, ANSI B16.47, MSS-SP44, API 605, AWWA C207-54T. Gaskets are also well known in the art and the invention nay be applied to a flange joint including any suitable gasket.

Under normal conditions, it is desirable that no sealing fluid leaks out into the environment. However, it is still desirable to use a safe sealing fluid that could safely leak to the environment. A safe sealing fluid may be defined as a fluid that can safely leak both into the process and out into the environment. For example, the safe sealing fluid may be selected from a group consisting of air, steam, water, nitrogen, helium, carbon dioxide, or combinations thereof. The safe sealing fluid may be an inert gas or liquid. In some embodiments, the safe sealing fluid may be a hydrocarbon, which may be a hydrocarbon with a boiling point higher than the temperature of the process. In such embodiments, it may be necessary to ensure compliance with any environmental regulations concerning the release of hydrocarbons. It will be understood that the safe sealing fluid may be a liquid or a gas. In some embodiments the safe sealing fluid may be a process fluid. For example, many processes involve a reaction between a hazardous chemical and a non-hazardous chemical, such as air. In such cases, the non-hazardous chemical, which will necessarily be compatible with the process and is also safe for environmental release, can be used as the safe sealing fluid.

The safe sealing fluid may be supplied at a higher pressure than the process fluid so that there is a purge of the safe sealing fluid into the process. For example, the pressure of the safe sealing fluid may be at least 1.05 times, preferably at least 1.1 times, more preferably at least 1.2 times, even more preferably at least 1.5 times the pressure of the process fluid. Advantageously the pressure of the safe sealing fluid is not more than 2 times, preferably not more than 1.75 times, more preferably not more than 1.6 times the pressure of the process fluid. In that way, excessive purging of the safe sealing fluid into the process is avoided. In some embodiments the purge flowrate of the safe sealing fluid into the process may be from 0.01 to 10 wt %, preferably 0.03 to 3 wt %, more preferably 0.1 to 1 wt %, of the flowrate of the process fluid.

Because the safe sealing fluid is at a higher pressure than the process fluid, the process fluid is prevented from leaking out through the flange joint. In effect, the method of the invention may replace a leak out through the flange joint with a. purge of a safe sealing fluid in through the flange joint. The positive pressure of the safe sealing fluid, compared to the process fluid, prevents the process fluid from contacting the external sealant. The safe sealing fluid thus provides a fluid barrier between the external sealant and the process fluid. The partial barrier restricts ingress of the sealant into the flange joint. The safe sealing fluid may be at a higher pressure than atmospheric pressure. A safe sealing fluid at a greater than atmospheric pressure may also act to prevent ingress of the sealant into the process.

The safe sealing fluid may be supplied from an intrinsically safe source. For example, the source of the safe sealing fluid may be the same compressor or pump as is used for the process fluid. hr that way the pressure of the safe sealing fluid may be intrinsically safe. For instance, if the safe sealing fluid supply is designed so that the pressure drop between the compressor and the flange joint is designed to be lower for the safe sealing fluid than for the process fluid, then the safe sealing fluid will always be at a higher pressure than the process fluid at the flange joint. Also, since a properly designed compressor or pump will be limited to a pressure below the design pressure of the apparatus, the safe sealing fluid will always he at a pressure below the design pressure of the flange joint.

The safe sealing fluid is supplied to an inner part of the flange joint. Typically two components joined by a flange joint will each have a mouth surrounded by a flange with a gasket between the flanges. The two flanges are fastened together so that the two mouths are aligned. A leak forms when one or both of the two flanges are deformed so that a gap is created between the flanges and the gasket. The process fluid can leak out through that gap. The safe sealing fluid may be supplied to the gap between the flanges and the gasket via an orifice in one of the flanges. In some cases it may be desirable to supply the safe sealing fluid through a plurality of orifices, which may be in one or both of the flanges. Thus, the safe sealing fluid may be supplied to an inner part of the flange joint between the flanges and radially inside the partial barrier. The safe sealing fluid may be supplied directly to the gap between the flanges and the gasket or it may be supplied to an inner part of the flange joint radially inside the partial barrier and radially outside the gasket. The safe sealing fluid is supplied via a slotted stud in the flange joint. A slotted stud, within the context of the present application, means a threaded stud having a longitudinal slot therein. The threads can be used when fastening two flanges together and the longitudinal slot allows the safe sealing fluid to be fed to a space between the two flanges. The slotted stud may be used in place of a conventional bolt. That may be advantageous as the existing bolt hole can be used, instead of a new hole in the flange being created. However, in some cases the safe sealing fluid may also be supplied through a hole in the flange joint itself The hole may be an existing hole, or it may be a hole created for that purpose.

The sealant may be a solid sealant. The sealant may be a sealant that is applied in liquid form and subsequently solidifies. For example, the sealant may be a hydrocarbon resin, an epoxy resin, or cement. An advantage of the present invention is that the sealant does not have to be compatible with the process fluid. That is because the safe sealing fluid creates a fluid barrier and prevents the process fluid from contacting the sealant.

A clamp may be attached to the flange joint and the solid sealant injected into a cavity between the clamp and the partial barrier. The clamp may extend around a portion of the circumference of the flange joint. The clamp may extend around the whole of the circumference of the flange joint. The flange joint may be enclosed in a box. In that case, the box may then be filled with sealant. Such a technique may find particular utility with smaller flange joints, for example joints on pipelines. On larger flange joints, for example on reactor vessels, a clamp is likely to be the preferred technique.

The partial barrier may restrict ingress of the sealant into the flange joint by creating a tortuous path that the sealant must negotiate to ingress into the clamp. The partial barrier may be around the outside circumference of the ring of bolts holding the flange joint together. The partial barrier may be a peened wire. Other examples of partial barrier include graphite rope, concrete, wood chips, wood strips and fibre material. If the sealant is applied as a liquid or paste, and subsequently solidifies, the main purpose of the partial barrier may be to prevent ingress of the sealant when it is initially applied. However, the partial barrier may still serve a useful purpose after such a sealant has solidified, by preventing the ingress of small lumps of solid sealant that may become detached from the main body of sealant. The safe sealing fluid prevents the process fluid from contacting the partial barrier. The partial barrier does not therefore have to be compatible with the process fluid.

According to a second aspect of the invention there is provided a flange joint comprising:
a. a partial barrier in an outer part of the flange joint;
b. a clamp attached to the flange joint so as to form a cavity between the clamp and the partial barrier;
c. a sealant in the cavity;
d. an orifice through which, in operation, a safe sealing fluid can be supplied to an inner part of the flange joint, thereby preventing a process fluid inside the flange joint from leaking out through the flange joint, and preventing the process fluid from contacting the sealant, wherein the orifice is a slotted stud in the flange joint.

The sealant may be a solid. sealant

The partial barrier may form a tortuous path that prevents the solid sealant from migrating into the flange joint.

The partial barrier may be a peened wire, graphite rope, concrete, wood chips, wood strips, fibre material, or a combination thereof.

The invention may be applied to any flange joint. Examples include, but are not limited to, joints on vessels, reactor vessels, heat exchangers, pumps and pipelines. The invention may be applied to flange joints containing processes operating in the slurry, gas or liquid phase. Therefore, according to a third aspect of the invention there is provided a vessel comprising a flange joint according to the second aspect of the invention.

For example, the vessel may be a reactor. The reactor may, for example, be used for dehydration, hydration, alkylation, nitration, oxidation, or similar processes. Examples of products that can be produced in reactors are listed in paragraph [0055] of US2006/0133972, which is incorporated herein by reference. For example, the reactor may be for the production of phthalic anhydride.

According to a fourth aspect of the invention there is provided a pipeline comprising a flange joint according to the second aspect of the invention.

It will be appreciated that any features described in relation to one aspect of the invention may be applied to another aspect of the invention. For example, a feature described in relation to the method of the first aspect of the invention, may be applied to the flange joint of the second aspect of the invention and vice versa.

### BRIEF DESCRIPTION OF FIGURES

The present invention will now be described, by way of example only, with reference to the following figures, of which:

FIG. 1 is a schematic view of a reactor vessel with a flange joint according to the present invention; and

FIG. 2 is a cross section of a flange joint according to the present invention.

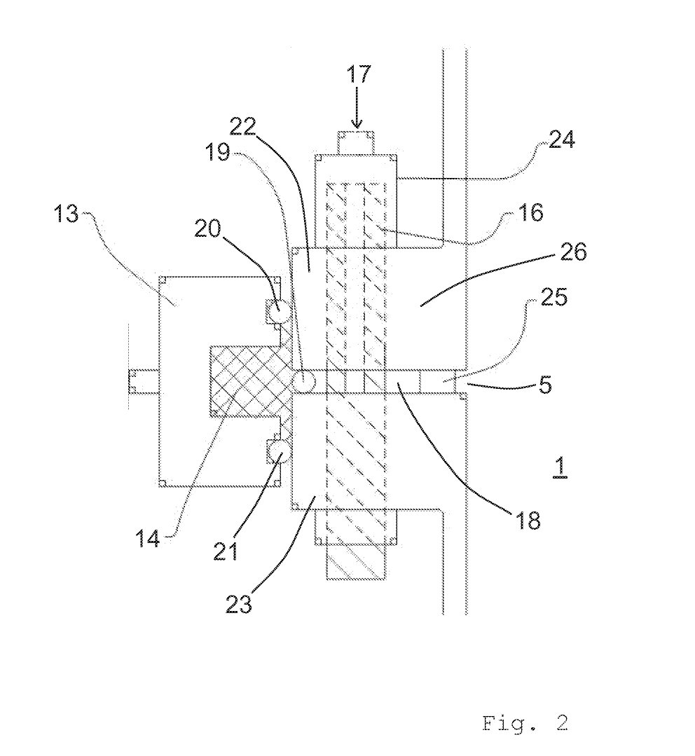

### DETAILED DESCRIPTION

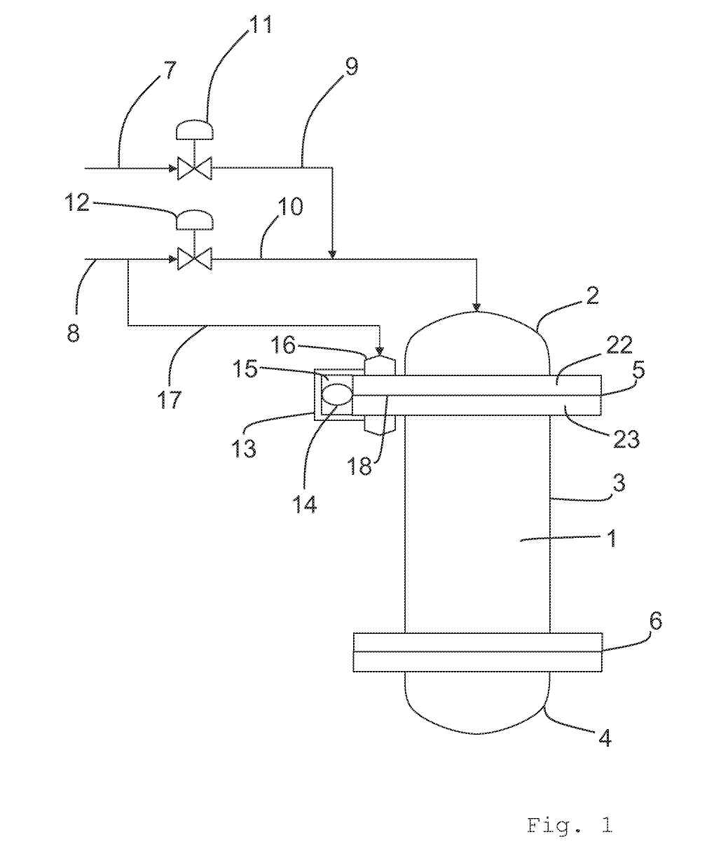

In FIG. 1 a reactor vessel 1 is formed of sections 2, 3 and 4. The sections are joined by flange joints 5 & 6. A hazardous chemical 7 and a non-hazardous chemical 8 are fed to the top of the reactor via lines 9 & 10 and control valves 11 & 12. Because chemical 7 is hazardous, it is important that it does not leak to the environment. Flange joint 5 has developed a leak and been sealed by a method according to the present invention. In FIGS. 1 & 2, a clamp 13 has been fitted to the flange joint 5 and a peened wire 19 inserted into the flange joint 5 to form a partial barrier. The clamp forms seals 20 & 21 with the outer end of the flanges 22 & 23 that form the flange joint 5. A sealant 14 has been applied in the cavity 15 between the clamp 13, peened wire 19 and the outer ends of the flanges 22 & 23 that form the flange joint 5. The sealant 14 is prevented from ingressing through the flange joint 5 by the peened wire 19 and has sealed the outside of the flange joint 5. A slotted stud 16 has replaced one of the conventional bolts holding flange joint 5 together. A cap nut 24 on the slotted stud 16 allows a flow of the non-hazardous chemical 8 to be supplied, via line 17 and longitudinal slot 26, to an inner part 18 of the flange joint 5. The line 17 comes from before control valve 12, so the pressure in line 17 is guaranteed to be higher than the pressure in the vessel 1. As a result, the non-hazardous chemical 8 will purge through flange joint 5, past leaking gasket 25 into the vessel 1. In doing so, the non-hazardous chemical 8 prevents fluid from within the vessel 1 from escaping through flange joint 5. Non-hazardous chemical 8 is therefore acting as a safe sealing fluid. The sealant 14 prevents the non-hazardous chemical 8 from escaping to the environment through flange joint 5. While it would be environmentally acceptable for such release to occur, it would be an inefficient method of sealing the flange joint 5 as a larger supply of non-hazardous chemical 8 would be required in line 17 in order to maintain a purge into vessel 1 along with the release to the environment.

While the embodiment of the invention described above considers a flange joint on a reactor vessel, it will be immediately apparent that the invention may be applied to any flange joint. It will also be apparent that the supply of non-hazardous chemical 8 via line 17 to cap nut 24 could, if desired, be replaced by a supply of another safe sealing fluid that was not already part of the process.

1. A method for preventing a process fluid from leaking out through a flange joint, the method comprising:
a. forming a partial barrier in an outer part of the flange joint;
b. applying a sealant to the outside of the flange joint, the partial barrier restricting ingress of the sealant into the flange joint; and
c. supplying a safe sealing fluid, at a pressure higher than the pressure of the process fluid, to an inner part of the flange joint, such that the safe sealing fluid prevents the process fluid from leaking out through the flange joint and prevents contact between the process fluid and the sealant, wherein the safe sealing fluid is supplied through a slotted stud in the flange joint.

2. A method according to claim 1, wherein the sealant is a solid sealant.

3. A method according to claim 1, wherein the safe sealing fluid is also supplied through a hole in the flange joint.

4. A method according to claim 1, wherein the partial barrier is a peened wire.

5. A method according to claim 1, wherein a clamp is attached to the flange joint and the solid sealant is injected into a cavity between the clamp and the partial barrier.

6. A method according to claim 1, wherein the safe sealing fluid is supplied from an intrinsically safe source.

7. A method according to claim 1, wherein the safe sealing fluid is selected from a group consisting of air, water, nitrogen, helium, carbon dioxide or combinations thereof.

8. A flange joint comprising:
a. a partial barrier in an outer part of the flange joint;
b. a clamp attached to the flange joint so as to form a cavity between the clamp and the partial barrier;
c. a sealant in the cavity;
d. an orifice through which, in operation, a safe sealing fluid can be supplied to an inner part of the flange joint, thereby preventing a process fluid inside the flange joint from leaking out through the flange joint, and preventing the process fluid from contacting the sealant, wherein the orifice is a slotted stud in the flange joint.

9. A flange joint according to claim 8, wherein the sealant is a solid sealant.

10. A flange joint according to claim 8, wherein the partial barrier forms a tortuous path that prevents the solid sealant from migrating into the flange joint.

11. A flange joint according to claim 8, wherein the partial barrier is a peened wire.

12. A vessel comprising a flange joint according to claim 8.

13. A vessel according to claim 12, wherein the vessel is a reactor for the production of phthalic anhydride.

14. A pipeline comprising a flange joint according to claim 8.
